(19) United States
(12) Patent Application Publication
(10) Pub. No.: US 2007/0065082 A1
(43) Pub. Date: Mar. 22, 2007

(54) Method for preparation of core rod assembly for overcladding, and perform and fiber produced from such core rod assembly

(75) Inventors: Parag Kulkarni, Aurangabad (IN); Dattatray Pasare, Aurangabad (IN)

Correspondence Address: JAMES RAY & ASSOCIATES, 2640 Pitcairn Road, Monroeville, PA, 15146, US

(73) Assignee: STERLITE OPTICAL TECHNOLOGIES LTD

(21) Appl. No.: 11/636,006

(22) Filed: Dec. 8, 2006

(30) Foreign Application Priority Data
Oct. 12, 2006 (IN) 1687/MUM/2006

(51) Int. Cl. G02B 6/02; C03B 18/00; C03B 37/15

(52) U.S. Cl. 385/123; 428/428; 65/407; 65/404; 65/421

(57) ABSTRACT

A method for preparation of core rod assembly suitable for overcladding comprising the steps of preparing core rod having reduced diameter, fixing glass rods at each of the opposite ends of the core rod having reduced diameter characterized in that the core rod with fixed glass rods at its opposite ends obtained is fire polished in a controlled manner and two step process to produce core rod assembly suitable for overcladding, wherein first step is hard fire polish and second step is soft fire polish is provided. A core rod assembly, and soot preform prepared from core rod assembly, and a daughter preform prepared from soot preform, and an optical fiber prepared from daughter preform are also provided.

### FIELD OF THE INVENTION

The present invention relates to method for preparation of core rod assembly for overcladding. Particularly, the present invention relates to a method for preparation of core rod assembly which is suitable for overcladding so as to form daughter preform which is suitable for fiber draw process. The present invention also relates to a core rod assembly for overcladding, and to the daughter preform and optical fiber produced from such core rod assembly.

### BACKGROUND OF THE INVENTION

Optical fibers are inherently versatile as a transmission medium for all forms of information, be it voice, video or data. The optical fibers are drawn from an optical fiber preform. The optical fiber of predetermined dimension is drawn either from the solid glass preform [mother preform] or from sintered preform [daughter preform] by subjecting one end of the preform [mother preform or daughter preform] to a high temperature, for example above 2000° C. The sintered preform [daughter preform] is prepared from a core rod having soot porous body [also referred as soot preform].

The daughter preform manufacturing process primarily involves a step of preparing the core rod comprising core of the fiber and part of clad which is followed by over-cladding. The core rod can be prepared by methods known in the art, such as modified chemical vapour deposition (MCVD), plasma chemical vapour deposition (PCVD), Atmospheric chemical vapour deposition (ACVD), vapour axial deposition (VAD) etc. The over-cladding of the core rod can be carried out by various methods, such as glass tube jacketing, ACVD soot over-cladding, VAD soot over-cladding, plasma over-cladding etc. Therefore, the daughter preform can be manufactured by any combination of the core rod manufacturing methods and the over-cladding preparation methods.

Typically, the daughter preform can be manufactured by any of the above-said conventional methods, for example by ACVD method, which is described herein for reference.

In accordance with a typical ACVD process to manufacture a soot porous body, as illustrated in accompanying FIG. 1, the preparation of soot porous body 1 comprises the following steps. The glass-forming precursor compounds are oxidized and hydrolyzed to form porous silica based materials 2. The porous silica based materials 2 are deposited on a tapered cylindrical member referred as mandrel 3, which can be any commercially available mandrel with or without any specific preparation, preferably with specific preparation to remove the contaminants therefrom which is provided with a handle rod 4 and fitted on a lathe 5 to form soot porous body 1.

During the step of deposition, the mandrel 3 is rotated in a direction as illustrated by an arrow 6 and also moved along its length with reference to burner 7 to deposit the soot particles 2 on the mandrel 3 for producing soot porous body 1. During the deposition process, the dopant chemicals for example GeCl₄ may also be deposited to form the core of the preform and later the dopant chemicals may be terminated to form clad of the preform. The amount of deposition of the clad region 9b and core region 9a is achieved to have any desired ratio diameter of clad region 9b to the diameter of core region 9a.

After completion of deposition, the soot porous body 1 is removed from lathe 5 along with mandrel 3 and handle rod 4, and the mandrel 3 is removed/detached, during the mandrel removal step, from the soot porous body 1 thereby resulting in formation of a hollow cylindrical soot porous body 8 (herein after referred to as hollow soot porous body) having a centerline 9 therethrough [FIG. 2].

The hollow soot porous body 8 thus formed comprises a core region 9a having a centerline hole 9 and a clad region 9b of the optical fiber preform [FIG. 3], and said core region 9a has refractive index greater than that of the clad region 9b.

After removal/detachment of mandrel 3 a centerline 9 is created inside the soot porous body 1.

Now referring to accompanying FIG. 4, the prepared hollow soot porous body 101 is transferred to the sintering furnace 100 in order to achieve dehydration, and sintering of the hollow soot porous body 101 to form dehydrated and sintered hollow glass body.

The dehydrated and sintered hollow glass body is subjected to step of collapsing of the centerline 102 to form a solid glass preform 103 [FIG. 5] with or without requiring any step of drilling or grinding or etching of the centerline 9/102 before steps of consolidation and collapsing.

Thus, the prepared hollow soot porous body 101 is dehydrated, sintered and collapsed to convert it into solid glass preform 103.

In a typical embodiment of ACVD method, the hollow soot porous body 8/101, one end of which is provided with a plug 116 is inserted inside the furnace 100 with the help of the handle rod 4/106. The driving mechanism (not shown) facilitates lowering of the hollow soot porous body 8/101 into the furnace 100. The furnace 100 comprises a glass muffle tube 110 having a diameter sufficient to accommodate the hollow soot porous body 8/101 and to adequately provide the environment necessary for dehydration, sintering and collapsing. The muffle tube 110 is suitable for heating to temperatures necessary for dehydration and simultaneous sintering and collapsing process steps with the heating means (not shown) which are suitably fitted to the sintering furnace 100.

The heating means selected may be suitable to create three heat zones inside the muffle tube 110 over a length. A thermocouple (not shown) provided in the furnace 100 measures the temperature of the hot zones inside the furnace created by the heating means, and the data measurement is fed to the temperature controller (not shown) that controls the temperature inside the muffle tube 110.

The furnace 100 is provided with an inlet port 115 located suitably on the furnace, preferably near the bottom of the muffle tube 110 for supplying desired gases in the furnace. The top end of the muffle tube 110 is suitably closed with the lid 113 to achieve the preferred temperature profile inside the muffle tube 110 and to maintain the same during the dehydration, and simultaneous sintering and collapsing process steps, and to avoid leakage of gases from the muffle tube 110 to the outside environment. A suction port 114 is suitably provided near the top of muffle tube 110 to facilitate evacuation of the gases from the muffle tube 110 as and when required or on completion of the process.

In accordance with the known art methods, the mother preform produced is subjected, in a conventional manner, to a step of reducing the diameter to form a core rod having reduced diameter, which is then subjected, in a conventional manner, to a step of overcladding to form a soot preform comprising soot porous body having core rod, also referred as soot preform, which is then subjected, in a conventional manner, to a sintering step to form a daughter preform, which is then subjected to a step of fiber draw to draw the fiber.

In accordance with methods known in the art, the opposite ends of the core rod having reduced diameter are first attached to glass rods by heating means before performing overcladding step thereon to form soot preform. This process step is typically known as core rod assembly preparation step.

Accordingly, a typical process for preparation of optical fiber from daughter preform comprises the steps of:
a) preparing the mandrel;
b) placing the mandrel over a lathe;
c) depositing soot particles on the mandrel to prepare a soot porous body;
d) removing the mandrel to form hollow soot porous body having capillary therethrough;
e) dehydrating the hollow soot porous body to form dehydrated soot porous body;
f) performing sintering step on dehydrated soot porous body to form sintered glass body;
g) performing collapsing step to collapse the capillary of the sintered glass body to form solid glass preform;
h) performing the step of reducing the diameter of the solid glass preform to form a core rod having reduced diameter;
i) performing core rod assembly preparation step to form a core rod assembly for the overcladding step;
j) performing overcladding step on the core rod assembly to form soot preform comprising soot porous body having core rod;
k) performing sintering step on the soot preform to form a daughter preform; and
l) performing fiber draw step on the daughter preform having peform cone of desired shape and dimensions including diameter to draw the fiber therefrom.

It may be noted that for the ease of understanding the soot preform comprising soot porous body having core rod is referred as “soot preform” which may not be confused with “mother preform” or “daughter preform”.

As described herein, in accordance with the known art, the process of core rod assembly preparation suitable for overcladding [above process step] involves attaching or fixing or welding opposite ends of the core rod to glass rods by heating to a temperature for attaching or fixing or welding the glass rods to the opposite ends of the core rod.

It has been observed that the known methods of core rod assembly preparation involve process step of heat treatment of opposite ends of the core rod to attach or fix or weld glass rods thereto. The known heat treatment process steps suffer from following drawbacks, disadvantages and limitations.

The main drawback of the known methods of core rod assembly preparation involving conventional process step of heat treatment of opposite ends of the core rod to attach or fix or weld [herein after for convenience referred as to fix or fixing] glass rods thereto is that it causes stress formation at and around the joints formed between the glass rod and core rod. The stress formation in the core rod assembly has been observed to cause breakage of the core rod assembly during its handling and deposition of soot thereon to form the soot preform.

The another main drawback of the known methods of core rod assembly preparation involving conventional process step of heat treatment of opposite ends of the core rod to fix glass rods thereto is that it causes physical defects, for example cracks and breaks at and around the joints formed between the glass rod and core rod, and physical defects such as cracks and flaws on the surface of the core rod assembly have been observed to cause bubbles and voids in the soot preform produced from such core rod assembly which in-turn results in breakage of the optical fiber during fiber drawing step, and hence, a loss of the productivity of the process.

The another problem of stress formation and formation of physical defects in the core rod assembly during conventional heat treatment process is that the breakage of the core rod assembly may take place at any time during the soot deposition which not only results in total loss of soot deposition, but also causes damage to the burner, because there is every possibility that the core rod assembly will fall on the burner meaning thereby the conventional heat treatment process suffer from time loss, production loss and financial loss.

It has been further observed that the stress formation and formation of physical defects in the core rod assembly also lead to transmission loss in the resulting optical fiber or distortion of other optical parameters, for example, polarization mode dispersion, cutoff wavelength etc.

If conventional heat treatment is performed by graphite resistance method it has been observed that due to relatively higher process time it causes graphite oxidation which in-turn results in formation of oxidation products, for example ash, graphite particles etc. which adheres to the core rod surface, and such contamination of the core rod with unwanted particles results in production of a daughter preform which will produce a fiber having increased transmission loss and poor strength.

Similarly, if conventional heat treatment is performed by lasers, such as carbon dioxide lasers, which are clean heat source to use, power consumption has been observed to be very high rendering the overall process very expensive.

Further, it has also been observed that large amount of thermal induced stress in the core rod at and around the joint of the core rod and glass rod area adversely effects joint strength which upon further processing may shatter the core rod.

Accordingly, the known methods of core rod assembly preparation are observed to be uneconomical for commercial applications.

### NEED OF THE INVENTION

Therefore, there is a need to have a method for preparation of core rod assembly for overcladding, particularly a method for preparation of core rod assembly which is suitable for overcladding so as to form daughter preform which is suitable for fiber draw process.

### OBJECT OF THE INVENTION

Accordingly, the main object of the present invention is to provide a method for preparation of core rod assembly which is suitable for overcladding so as to form daughter preform which in-turn is suitable for fiber draw process.

The another main object of the present invention is to provide a method for preparation of core rod assembly wherein no stress is formed at and around the joints formed between the glass rod and core rod meaning thereby the core rod assembly produced will not break, due to stress, during its handling and deposition of soot thereon to form the soot preform.

Still another main object of the present invention is to provide a method for preparation of core rod assembly wherein formation of physical defects, for example cracks and breaks at and around the joints formed between the glass rod and core rod is reduced, and hence, possibility of formation of bubbles and voids in the soot preform produced from such core rod assembly is reduced meaning thereby possibility of breakage of the optical fiber, due to physical defects during fiber drawing step is reduced, and accordingly, possibility of loss of productivity of the process is reduced.

Yet another main object of the present invention is to provide a method for preparation of core rod assembly wherein possibility of stress formation and formation of physical defects in the core rod assembly is eliminated or greatly reduced, and hence, the possibility of breakage of the core rod assembly is eliminated or greatly reduced meaning thereby possibility of loss of soot deposition and damage of the burners is eliminated or greatly reduced.

Further object of the present invention is to provide a method for preparation of core rod assembly for overcladding wherein the core rod assembly is suitable for overcladding and to form suitable daughter preform.

One particular object of the present invention is to provide a method for preparation of core rod assembly for overcladding which can overcome drawbacks, disadvantages and limitations of the prior art.

Another particular object of the present invention is to provide a method for preparation of core rod assembly for overcladding wherein no or reduced physical defects and stress is caused in the core rod, and hence the possibility of transmission loss in the resulting optical fiber or distortion of other optical parameters, for example, polarization mode dispersion, cutoff wavelength etc. is greatly reduced.

Still another particular object of the present invention is to provide a method for preparation of core rod assembly for overcladding which even by performing heating by graphite resistance method does not cause graphite oxidation, and hence, overcomes associated problems of formation of oxidation products, for example ash, graphite particles etc. which are known to adhere to the core rod surface. Accordingly, the present invention aims to provide a method for core rod assembly preparation wherein possibility of contamination of core rod with unwanted particles is greatly reduced, and hence, the daughter preform produced from such core rod assembly will produce a fiber having decreased transmission loss and increased strength.

Still further particular object of the present invention is to provide a method for preparation of core rod assembly for overcladding which even if heating is performed by lasers, such as carbon dioxide lasers, does not require higher power consumption meaning thereby which is relatively less expensive.

Yet further particular object of the present invention is to provide a method for preparation of core rod assembly for overcladding wherein possibility of thermal induced stress in the core rod at and around the joint of the core rod and glass rod area is greatly reduced meaning thereby the joint strength is not adversely effected, and hence, the further processing of the produced core rod assembly will be safer and convenient.

It is also an object of the present invention to provide a core rod assembly which is suitable for overcladding to form a suitable daughter preform which will be capable of fiber draw process to produce suitable optical fiber.

The other objects and advantages of the present invention will be apparent from the following description when read in conjunction with the accompanying drawings which are incorporated for the purpose of illustration of present invention and not to limit scope thereof.

### BRIEF DESCRIPTION OF THE INVENTION

The inventors have surprisingly observed that if core rod is heated in a controlled manner to have its controlled heating after fixing the glass rods at its opposite ends and before performing step of overcladding, the problems associated with known methods of core rod assembly preparation as described herein above can be overcome and a core rod assembly suitable for overcladding which in-turn is suitable for producing desired daughter preform.

Accordingly, the present invention provides a method for preparation of core rod assembly suitable for overcladding comprising the steps of:
a) preparing core rod having reduced diameter;
b) fixing glass rods at each of the opposite ends of the core rod having reduced diameter; characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish.

The other embodiments and advantages of the present will be apparent from the following description when read in conjunction with the accompanying drawings which are incorporated for illustration of preferred embodiments of the present invention and are not intended to limit scope thereof.

### BREIF DESCRIPTION OF THE ACCOMPANYING DRAWINGS

FIG. 1 illustrates a schematic representation of deposition process over a mandrel to produce a soot porous body.

FIG. 2 illustrates a schematic representation of hollow soot porous body having centerline therethrough after removal of mandrel from the soot porous body.

FIG. 3 illustrates a schematic cross-sectional view of hollow soot porous body having centerline therethrough after removal of mandrel from the soot porous body.

FIG. 4 illustrates a schematic representation of hollow soot porous body inside the sintering furnace after removal of mandrel from the soot porous body.

FIG. 5 illustrates a hollow soot porous body having centerline therethrough after removal of mandrel from the soot porous body which is subjected to steps of dehydration, sintering and collapsing to produce a solid glass preform.

FIG. 6 illustrates a schematic representation of the mother preform comprising a core and a clad provided with handle rod on each of its opposite ends.

FIG. 6a illustrates a schematic representation of the daughter preform comprising a core rod and overclad.

FIG. 7 illustrates a schematic representation of process step of fixing a glass rod at one of the two opposite ends of the core rod in accordance with method for preparing a core rod assembly according to one embodiment of the present invention.

FIG. 8 illustrates a schematic representation of process step of fixing a glass rod at another opposite end of the core rod in accordance with method for preparing a core rod assembly according to one embodiment of the present invention.

FIG. 9 illustrates a schematic representation of core rod assembly ready for controlled heat treatment in accordance with method of the present invention.

FIG. 10 illustrates a schematic representation of process step of heat treatment of the core rod assembly in accordance with method for preparing a core rod assembly according to one embodiment of the present invention.

FIG. 11 illustrates a schematic representation of the temperature profile of the hard fire polish heat treatment process step of the core rod assembly in accordance with one embodiment of the present invention.

FIG. 12 illustrates a schematic representation of the burner speed profile of the hard fire polish heat treatment process step of the core rod assembly in accordance with one embodiment of the present invention.

FIG. 13 illustrates a schematic representation of temperature profile of the soft fire polish heat treatment process step of the core rod assembly in accordance with one embodiment of the present invention.

FIG. 14 illustrates a schematic representation of burner speed profile of the soft fire polish heat treatment process step of the core rod assembly in accordance with one embodiment of the present invention.

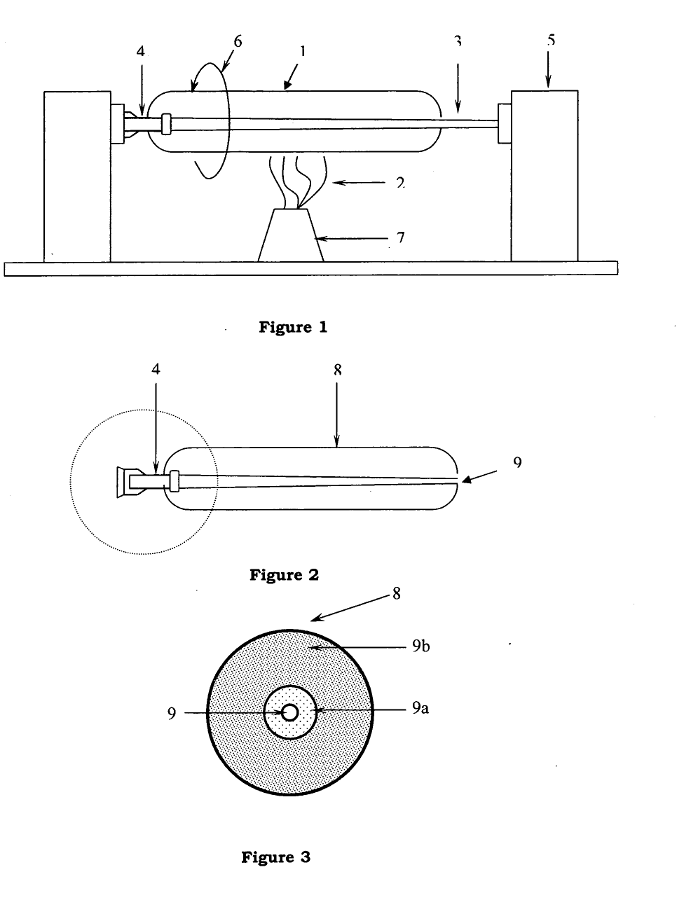

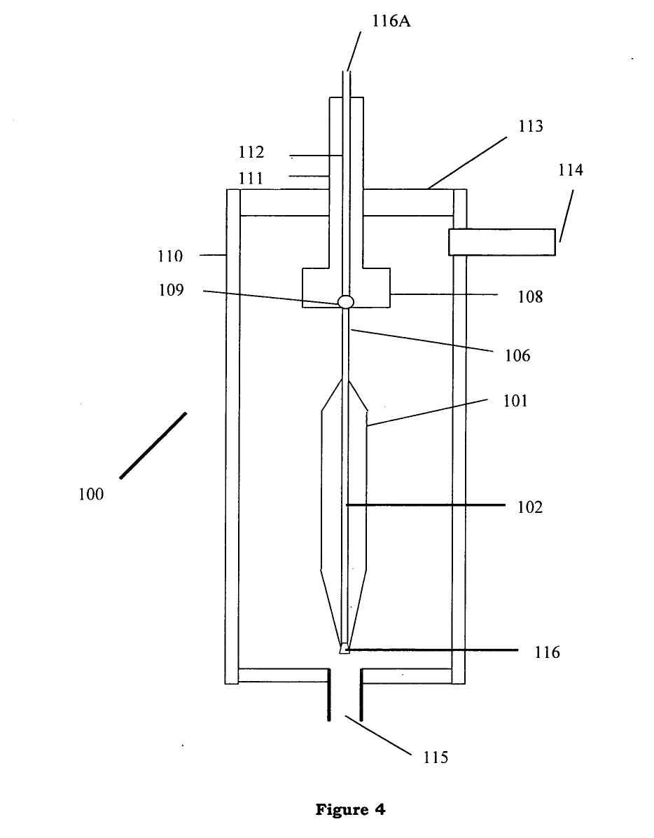

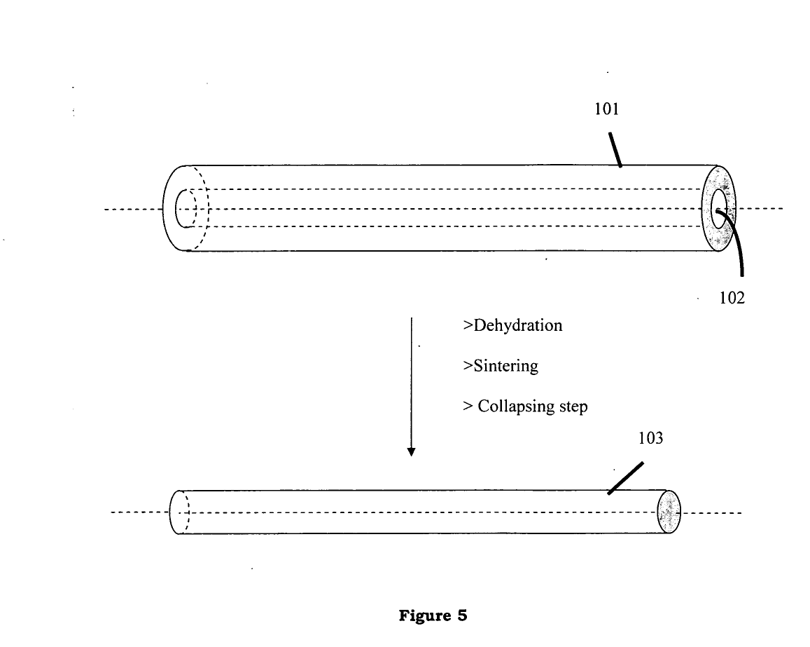

### DETAILED DESCRIPTION AND PREFERRED EMBODIMENTS OF THE INVENTION

Accordingly, the present invention relates to a method for preparation of core rod assembly suitable for overcladding comprising the steps of:
a) preparing core rod having reduced diameter;
b) fixing glass rods at each of the opposite ends of the core rod having reduced diameter; characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish.

In accordance with one of the preferred embodiments of the present invention, the overcladding step is performed on the core rod assembly produced in above process step-c) to produce a core rod having overclad referred as soot preform comprising soot porous body having core rod.

In accordance with another preferred embodiment of the present invention, the soot preform comprising soot porous body having core rod produced from core rod having overclad which in-turn is produced produced from core rod assembly produced in above process step-c) is subjected to sintering step to form a daughter preform, which is suitable for storage or immediate processing for fiber draw step.

Accordingly, in one embodiment, the present invention relates to a method for preparation of core rod having overcladding, that is, soot preform comprising soot porous body having core rod comprising the steps of:
a) preparing core rod having reduced diameter;
b) fixing glass rods at each of the opposite ends of the core rod having reduced diameter; characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod.

Accordingly, in another embodiment, the present invention relates to a method for preparation of daughter preform comprising the steps of:
a) preparing core rod having reduced diameter;
b) fixing glass rods at each of the opposite ends of the core rod having reduced diameter; characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod; and
e) performing the sintering step on the soot preform produced in above process step-d) to form a daughter preform.

Accordingly, in still another embodiment, the present invention relates to a method for preparation of optical fiber comprising the steps of:
a) preparing core rod having reduced diameter;
b) fixing glass rods at each of the opposite ends of the core rod having reduced diameter; characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod;
e) performing the sintering step on the soot preform produced in above process step-d) to form a daughter preform; and
f) performing fiber draw step on the daughter preform obtained in above process step-e) to draw the fiber therefrom.

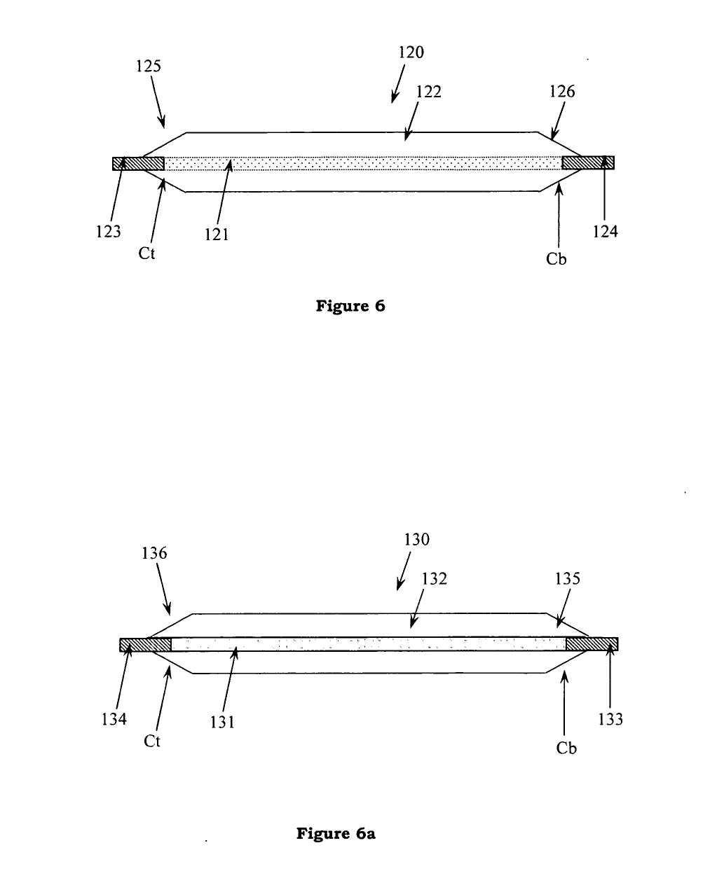

Now referring to accompanying FIG. 6, the mother preform 120 comprises a core 121 and a clad 122 and is provided with dummy glass handle 123 and 124 on each opposite ends 125 and 126 thereof for the purpose of handling and holding the preform. The opposite end 125 [or 126] comprises a cone shape structure Cb [or Ct].

The accompanying FIG. 6a illustrates the daughter preform 130 comprising a core rod 131 and a overclad 132 wherein the extended parts 133 and 134 on the opposite ends 135 and 136 of the core rod 131 serve the purpose of handle rods on each of the opposite ends of the core rod 131 for handling and holding the preform. The opposite ends 135 and 136 comprise a cone shape structure Cb [or Ct].

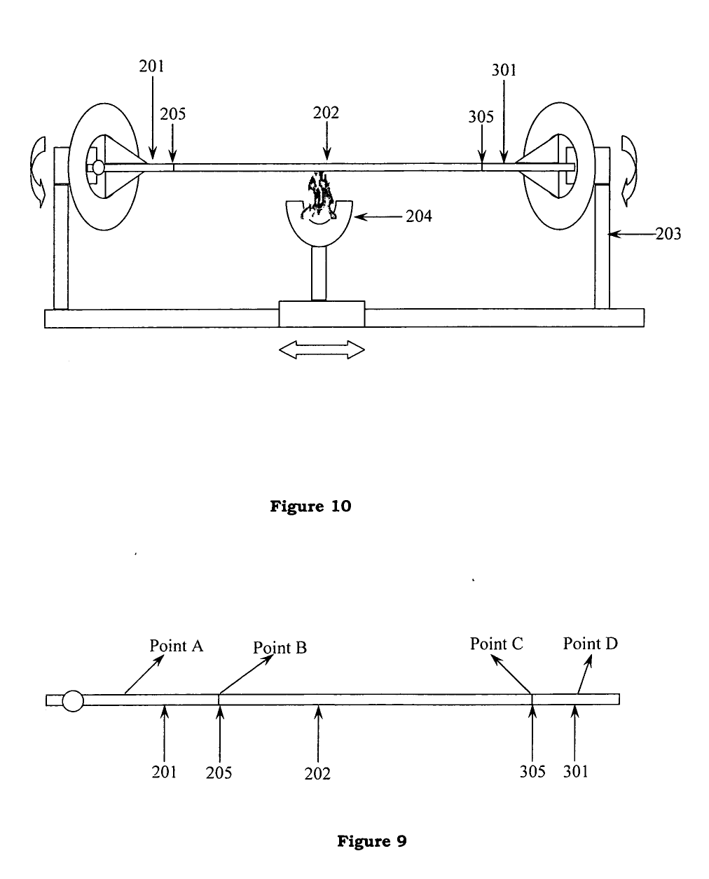

Now referring to accompanying FIG. 7 illustrating a schematic representation of process step of fixing a glass rod at one of the two opposite ends of the core rod in accordance with method of the present invention, a glass rod 201 is fixed onto one end of the core rod 202 after attaching the core rod over a lathe 203 having rotation means [not shown] to rotate the core rod and glass rod, and heating means 204 for heating the glass rod 201 and core rod 202 to form a joint 205 between the two [FIG. 9].

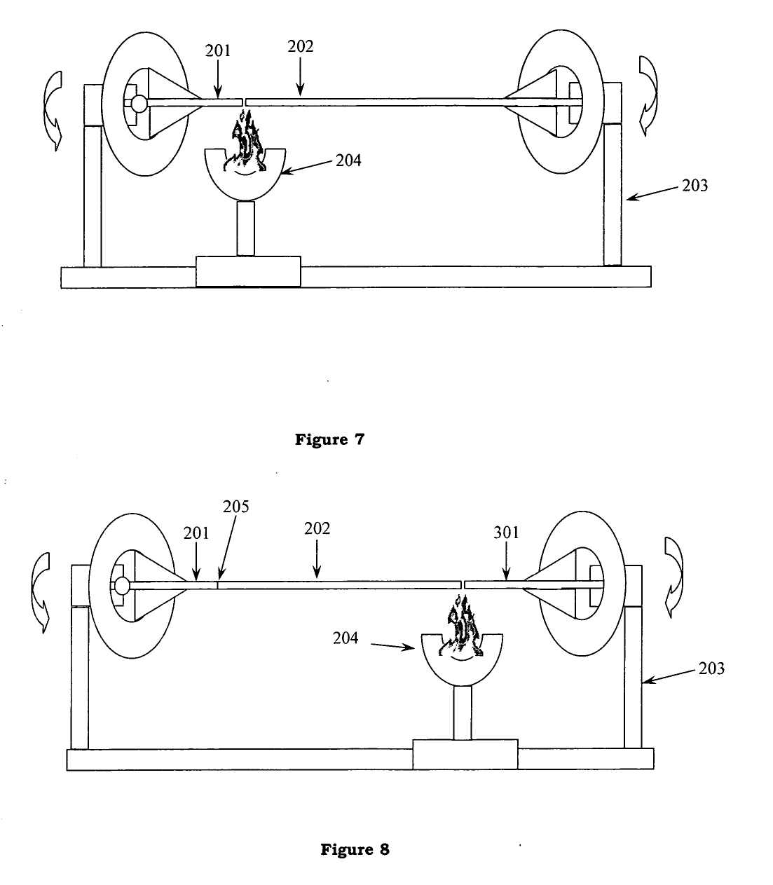

Now referring to accompanying FIG. 8 illustrating a schematic representation of process step of fixing a second glass rod at another opposite end of the core rod in accordance with method of the present invention a second piece of glass rod 301 is fixed onto another end of the core rod 202 after attaching the core rod over a lathe 203 having rotation means [not shown] to rotate the core rod and second glass rod, and heating means 204 for heating the glass rod 301 and core rod 202 to form a joint 305 between the two [FIG. 9].

The core rod assembly prepared in accordance with present invention is illustrated in accompanying FIG. 9 which comprises one glass rod 201 fixed onto one end of the core rod 202 forming a joint 205 and second glass rod 301 fixed onto another end of the core rod 202 forming a joint 305. The points A, B, C and D are marked on the core rod before start of controlled heat treatment in accordance with present invention, wherein point A is marked at suitable end of the one glass rod 201, and point D is marked at a suitable end of another glass rod 301 in a manner that the glass rods are suitably held in the lathe for controlled heat treatment in accordance with present invention. The points B and C are the points of joint 205 formed between one glass rod 201 and core rod 202 and joint 305 formed between second glass rod 301 and core rod 202 respectively.

In accordance with present invention, the said first step of hard fire polish is performed by increasing the temperature from room temperature to a temperature varying from about 1400° C. to about 1800° C. from point A to point B on the core rod, maintaining this temperature within said range varying from about 1400° C. to about 1800° C. from point B to point C on the core rod followed by reducing said temperature varying within said range varying from about 1400° C. to about 1800° C. to a temperature of about 300° C. from point C to point D on the core rod.

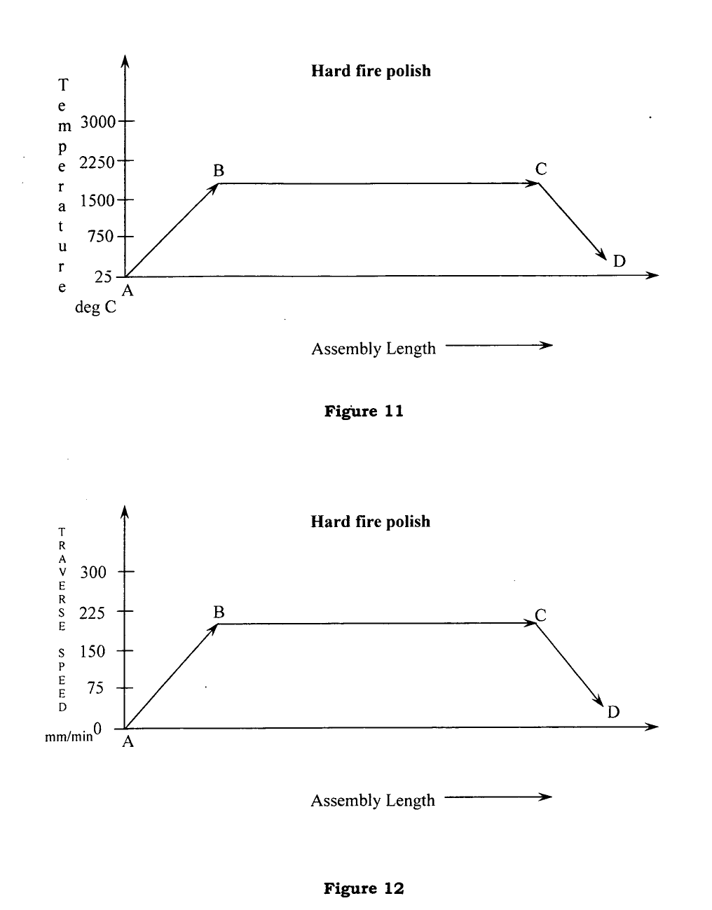

The above temperature profile of the first hard fire polish heat treatment process step of the core rod assembly in accordance with one embodiment of the present invention is illustrated in FIG. 11.

In accordance with present invention, the said second step of soft fire polish is performed by increasing the temperature from a temperature of about 300° C. to a temperature varying from about 1100° C. to about 1250° C. from point D to point C on the core rod, maintaining this temperature within said range varying from about 1100° C. to about 1250° C. from point C to point B on the core rod followed by reducing said temperature varying within said range varying from about 1100° C. to about 1250° C. to a temperature of about room temperature from point B to point A on the core rod.

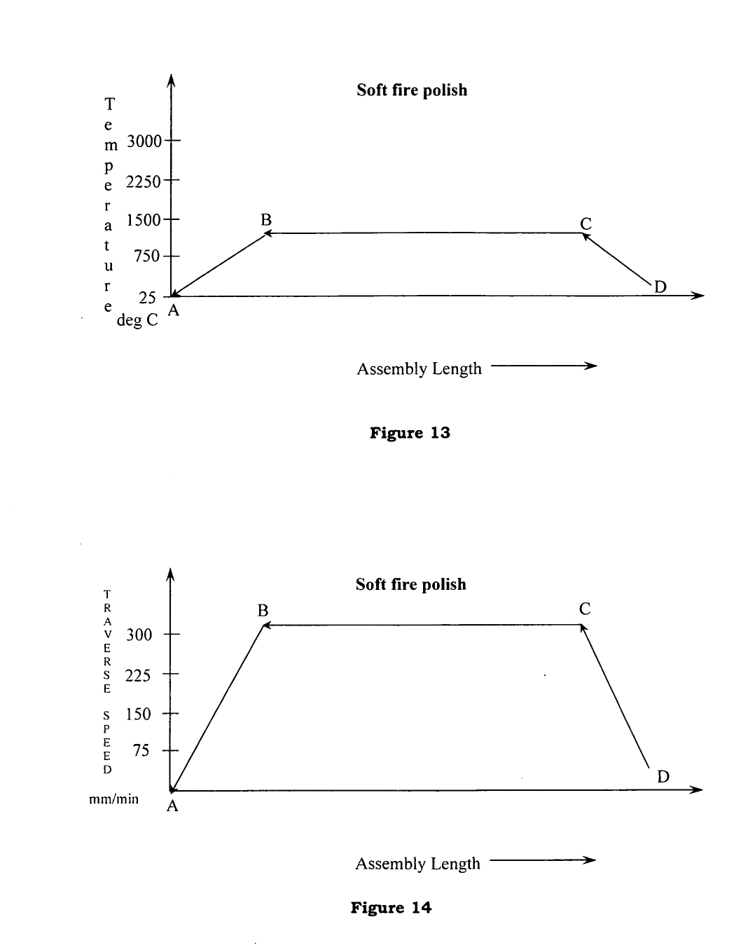

The above temperature profile of the second soft fire polish heat treatment process step of the core rod assembly in accordance with one embodiment of the present invention is illustrated in FIG. 13.

In accordance with present invention, the said first step of hard fire polish is performed by changing said temperature from point A to D while increasing the burner speed from a speed of zero to a speed varying from about 150 to about 250 mm/min from point A to point B on the core rod, maintaining said burner speed varying within said range varying from about 150 to about 250 mm/min from point B to point C on the core rod followed by reducing said burner speed varying within said range varying from about 150 to about 250 mm/min to a speed of about 50 mm/min from point C to point D on the core rod.

The above burner speed profile of the first hard fire polish heat treatment process step of the core rod assembly in accordance with one embodiment of the present invention is illustrated in FIG. 12.

In accordance with present invention, the said second step of soft fire polish is performed by changing said temperature from point D to A while increasing the burner speed from a speed of about 50 mm/min to a speed varying within a range varying from about 300 to about 350 mm/min from point D to point C on the core rod, maintaining said burner speed varying within said range varying from about 300 to about 350 mm/min from point C to point B on the core rod followed by reducing said burner speed from said speed varying within said range varying from about 300 to about 350 mm/min to a zero speed from point C to point D on the core rod.

The above burner speed profile of the first hard fire polish heat treatment process step of the core rod assembly in accordance with one embodiment of the present invention is illustrated in FIG. 14.

It may be noted that the present invention is not restricted by performing the first hard fire polish step from point A to D and second soft fire polish step from point D to A. One may also perform these steps in reverse direction, that is first hard fire polish step from point D to A and second soft fire polish step from point A to D. Accordingly, the present invention is restricted by performing second soft fire polish step in direction opposite to the direction of first hard fire polish step.

In accordance with one of the preferred embodiments of the present invention, the fire polish, that is, the controlled heat treatment of the core rod assembly is carried out while rotating the core rod assembly to achieve the uniform heat treatment. Preferably, the rotation speed varies from about 50 to about 70 rpm.

It has been found that on following above described controlled heat treatment method of the present invention no stress formation takes place at and around the joints formed between the glass rod and core rod. Accordingly, no breaks have been observed in the core rod assembly produced by present method during its handling and deposition of soot thereon to form the soot preform.

It has also been found that on following above described controlled heat treatment method of the present invention, the formation of physical defects, for example cracks and breaks at and around the joints formed between the glass rod and core rod is greatly reduced, and hence, the possibility of formation of bubbles and voids in the soot preform produced from such core rod assembly is greatly reduced meaning thereby the possibility of breakage of the optical fiber, due to physical defects during fiber drawing step is greatly reduced, and accordingly, the possibility of loss of productivity of the process is greatly reduced, which make the present method economically viable.

As the present method has been found to be free from stress formation and formation of physical defects in the core rod assembly, the possibility of breakage of the core rod assembly during soot deposition is eliminated or greatly reduced meaning thereby the possibility of loss of soot deposition and damage of the burners is eliminated or greatly reduced.

In accordance with present invention, the core rod with reduced diameter can be prepared by any method. As exemplary embodiment, the core rod having reduced diameter may be prepared in following manner:
i) preparing the mandrel;
ii) placing the mandrel over a lathe;
iii) depositing soot particles on the mandrel to prepare a soot porous body;
iv) removing the mandrel to form hollow soot porous body having capillary therethrough;
v) dehydrating the hollow soot porous body to form dehydrated soot porous body;
vi) performing sintering step on dehydrated soot porous body to form sintered glass body;
vii) performing collapsing step to collapse the capillary of the sintered glass body to form solid glass preform; and
viii) performing the step of reducing the diameter of the solid glass preform to form a core rod having reduced diameter.

It is apparent from the foregoing description that the presently disclosed method has overcome disadvantages, limitations and drawbacks of the prior art.

It may be noted that various terms, for example adjustable mandrel, soot porous body, hollow soot porous body, capillary, dehydrated soot porous body, sintered glass body, solid glass preform, core rod having reduced diameter, soot porous body having core rod, core rod, mother preform, soot preform, daughter preform, preform end, preform cone, sintered core rod etc. as employed herein are merely intended to illustrate the present invention and are not intended to restrict scope of the present invention. It is obvious for the persons skilled in the art that alternative terms may also be employed to describe the present method without deviating from the intended scope of the present invention.

It may also be noted that the presently disclosed method has been described with reference to ACVD method. However, the present method is suitable even for other alternative methods known for producing mother preform and daughter preform.

1. A method for preparation of core rod assembly suitable for overcladding comprising the steps of:
a) preparing core rod having reduced diameter;
b) fixing glass rods at each of the opposite ends of the core rod having reduced diameter;
characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish.

2. A method for preparation of soot preform comprising soot porous body having core rod comprising the steps of:
a) preparing core rod having reduced diameter;
b) fixing glass rods at each of the opposite ends of the core rod having reduced diameter;
characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod.

3. A method as claimed in claim 1, wherein said first step of hard fire polish is performed by increasing the temperature from room temperature to a temperature varying from about 1400° C. to about 1800° C. from point A to point B on the core rod, maintaining this temperature within said range varying from about 1400° C. to about 1800° C. from point B to point C on the core rod followed by reducing said temperature varying within said range varying from about 1400° C. to about 1800° C. to a temperature of about 300° C. from point C to point D on the core rod.

4. A method as claimed in claim 1, wherein said second step of soft fire polish is performed by increasing the temperature from a temperature of about 300° C. to a temperature varying from about 1100° C. to about 1250° C. from point D to point C on the core rod, maintaining this temperature within said range varying from about 1100° C. to about 1250° C. from point C to point B on the core rod followed by reducing said temperature varying within said range varying from about 1100° C. to about 1250° C. to a temperature of about room temperature from point B to point A on the core rod.

5. A method as claimed in claim 1, wherein said first step of hard fire polish is performed by changing said temperature from point A to D while increasing the burner speed from a speed of zero to a speed varying from about 150 to about 250 mm/min from point A to point B on the core rod, maintaining said burner speed varying within said range varying from about 150 to about 250 mm/min from point B to point C on the core rod followed by reducing said burner speed varying within said range varying from about 150 to about 250 mm/min to a speed of about 50 mm/min from point C to point D on the core rod.

6. A method as claimed in claim 1, wherein said second step of soft fire polish is performed by changing said temperature from point D to A while increasing the burner speed from a speed of about 50 mm/min to a speed varying within a range varying from about 300 to about 350 mm/min from point D to point C on the core rod, maintaining said burner speed varying within said range varying from about 300 to about 350 mm/min from point C to point B on the core rod followed by reducing said burner speed from said speed varying within said range varying from about 300 to about 350 mm/min to a zero speed from point C to point D on the core rod.

7. A method as claimed in claim 1, wherein said first step of hard fire polish and said second step of soft fire polish are carried in reverse directions.

8. A method as claimed in claim 3, wherein the temperature profile of FIG. 11 is followed.

9. A method as claimed in claim 4, wherein the temperature profile of FIG. 13 is followed.

10. A method as claimed in claim 5, wherein the burner speed profile of the FIG. 12 is followed.

11. A method as claimed in claim 6, wherein the burner speed profile of the FIG. 14 is followed.

12. A method as claimed in claim 1, wherein the fire polish of the core rod assembly is carried out while rotating the core rod assembly.

13. A core rod assembly as and when prepared by a method as claimed in claim 1.

14. A soot preform as and when prepared from core rod assembly as claimed in claim 13.

15. A daughter preform as and when prepared from soot preform as claimed in claim 14.

16. An optical fiber as and when prepared from daughter preform as claimed in claim 15.

17. A method for preparation of daughter preform as claimed in claim 15 comprising the steps of:
a) preparing core rod having reduced diameter;
b) fixing glass rods at each of the opposite ends of the core rod having reduced diameter;
characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod; and
e) performing the sintering step on the soot preform produced in above process step-d) to form a daughter preform.

18. A method for preparation of optical fiber as claimed in claim 16 comprising the steps of:
a) preparing core rod having reduced diameter;
b) fixing glass rods at each of the opposite ends of the core rod having reduced diameter;
characterized in that
c) the core rod with fixed glass rods at its opposite ends obtained in above process step-b) is fire polished in a controlled manner and two step process to produce core rod assembly suitable for overcladding, wherein first step is hard fire polish and second step is soft fire polish;
d) performing the overcladding step on the core rod assembly produced in above process step-c) to produce a core rod having overcladding, that is soot preform comprising soot porous body having core rod;
e) performing the sintering step on the soot preform produced in above process step-d) to form a daughter preform; and
f) performing fiber draw step on the daughter preform obtained in above process step-e) to draw the fiber therefrom.

19. A soot preform as and when prepared by method as claimed in claim 2.
